(19) United States
(12) Patent Application Publication
(10) Pub. No.: US 2011/0050415 A1
(43) Pub. Date: Mar. 3, 2011

(54) FOOD STORAGE CONTAINER

(75) Inventor: Chao-Tsung Fan, Tu-Cheng (TW)

(73) Assignee: HON HAI PRECISION INDUSTRY CO., LTD., Tu-Cheng (TW)

(21) Appl. No.: 12/604,407

(22) Filed: Oct. 23, 2009

(30) Foreign Application Priority Data
Aug. 26, 2009 (CN) 200910306098.2

(51) Int. Cl. G08B 21/00; B65D 43/16

(52) U.S. Cl. 340/540; 220/810

(57) ABSTRACT

A food storage container comprises a body for containing food, a cap, and an alarm module provided on one side of the body. The alarm module comprises a switch, a control unit to set an expiration date, a timing unit to show a present date and a present hour and to time, a buzzer, and a processing unit to obtain a time period difference between the present date and the expiration date. The body and the cap provide air-tight effect of food. When a time duration between the present date and the expiration date is smaller than a predetermined value, the buzzer will sound and issue notification that the food inside the container will be expired.

### BACKGROUND

1. Technical Field

The present application is related to a food storage container.

2. Description of Related Art

Food usually must be consumed before a certain date to avoid spoilage. However, people cannot always remind themselves of the expiration dates, and usually forget the expiration dates and resulting in food spoiling. To prevent food spoiling and to remind people of the expiration dates, it is desirable to have a food storage container displaying expiration dates and issuing notification when the expiration dates approach.

### BRIEF DESCRIPTION OF THE DRAWINGS

FIG. 1 is a schematic drawing showing a food storage container as disclosed according to an embodiment.

FIG. 2 is a schematic block diagram showing construction of the alarm module of the food storage container of FIG. 1.

### DETAILED DESCRIPTION

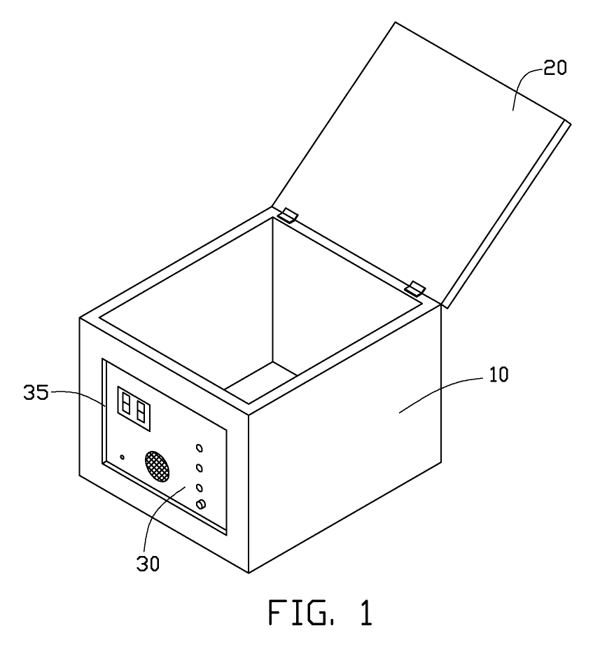

Referring to FIG. 1, a food storage container of the present application, in accordance with an embodiment, comprises a body 10, a cover 20, and an alarm module 30. The body 10 is embodied substantially as a cuboid with an open top, and the alarm module 30 is provided on one side thereof. The cover 20 is pivotally connected to one edge of the open top side, providing air-tight effect of the interior of the body 10.

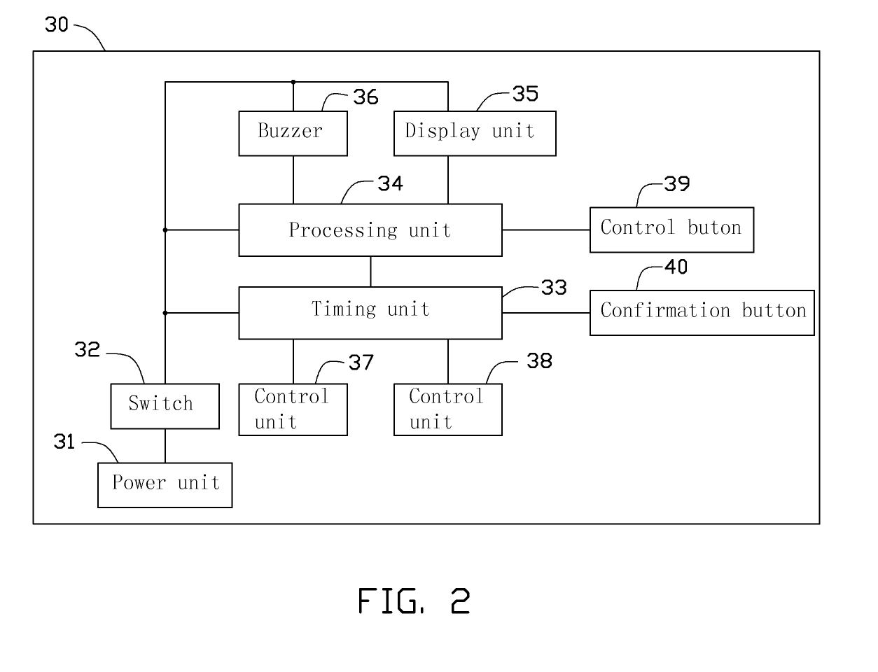

As shown in FIG. 2, the alarm module 30 comprises a power unit 31, a switch 32, a timing unit 33, a processing unit 34, a display unit 35, a buzzer 36, two control units 37 and 38, a control button 39 and a confirmation button 40.

The power unit 31 is configured for providing power of the alarm module 30, and the switch 32 is configured for turning on and off the alarm module 30. The control units 37 and 38 are configured for being connected to the timing unit 33, with the control unit 37 being configured for setting days and the control unit 38 being configured for setting hours for an acceptable consumption duration of the food stored inside the body 10. The timing unit 33 is configured for timing the acceptable consumption duration when the confirmation button 40 is pressed.

The timing unit 33, the display unit 35, and the buzzer 36 are configured for being connected to the processing unit 34. The processing unit 34 is configured for receiving timing signals from the timing unit 33, and for obtaining a time period difference in which the acceptable consumption duration stored by the control unit 37 has the present date of the timing unit 33 subtracted therefrom. The processing unit 34 is also configured for obtaining a time period difference for hours of the remaining acceptable consumption duration.

The processing unit 34 further stores a predetermined value, and when the countdown period of the acceptable consumption duration falls below the predetermined value, the processing unit 34 directs the buzzer 36 to sound, issuing notification of the forthcoming expiration. A control button 39 is configured for directing the display unit 35 to display remaining hours or days obtained by the timing unit 33.

After food is secured in the body 10 and the cover 20 placed to provide air-tight effect of the interior, activation of switch 32 initiates the alarm module 30. If the acceptable consumption duration of food inside the box 10 is less than a certain days (for example, four days), the control unit 38 can be set to calculate hours of the duration. If the taste period of food inside the body 10 exceeds a certain days, days of the acceptable consumption duration can be calculated. After the confirmation button 40 is activated, the timing unit 33 is initiated. The processing unit 34 receives the timing signals of the timing unit 33, obtains a time period difference in days or hours for the remaining acceptable consumption duration stored by the control unit 37, or the control unit 38 subtracts the present date of the timing unit 33, and displays the time period difference through the display unit 35. When the duration difference is less than a predetermined value, the buzzer 36 sounds to provide notification of the forthcoming expiration.

While the invention has been described by way of example and in terms of preferred embodiment, it is to be understood that the invention is not limited thereto.

To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A food storage container, comprising:
a body for containing food;
a cap arranged on one side of the body, for providing air-tight effect inside the body;
an alarm module provided on another side of the body, comprising:
a switch to turn the alarm module on and off,
a control unit to set an expiration date of food inside the body,
a timing unit to show a present date and a present hour, and to time,
a buzzer,
a processing unit to enable the buzzer sound when a time duration between the present date and the expiration date is less than a predetermined value, and
a power unit to provide power of the processing unit, the timing unit, the control unit and the buzzer.

2. The food storage container as claimed in claim 1, wherein the alarm module further comprises a display unit configured for displaying the time duration between the expiration date of the food and the present date in days and in hours.

3. The food storage container as claimed in claim 3, wherein the alarm module further comprises a control button to enable the processing unit display the time duration when the control button is activated.

4. The food storage container as claimed in claim 1, wherein the cap is pivotally connected to the body.
